(19) United States
(12) Patent Application Publication
(10) Pub. No.: US 2003/0104791 A1
(43) Pub. Date: Jun. 5, 2003

(54) Adding peripherals to mobile device via smart interchangeable cover

(76) Inventors: G. Eric Engstrom, Kirkland, WA (US); Peter Zatloukal, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/334,739

(22) Filed: Dec. 31, 2002

Related U.S. Application Data
(63) Continuation-in-part of application No. 10/301,432, filed on Nov. 20, 2002.
Application No. 10/301,432 is a continuation-in-part of application No. 10/087,098, filed on Mar. 1, 2002.
Application No. 10/301,432 is a continuation-in-part of application No. 09/932,154, filed on Aug. 17, 2001.
(60) Provisional application No. 60/306,326, filed on Jul. 17, 2001.
(60) Provisional application No. 60/292,123, filed on May 17, 2001.
(60) Provisional application No. 60/419,001, filed on Oct. 15, 2002.

(51) Int. Cl. H04M 1/00

(52) U.S. Cl. 455/90; 455/550

(57) ABSTRACT

An interchangeable cover is endowed with one or more peripherals complementary electronics to add the one or more peripherals to a mobile device, to which the interchangeable cover is attached. In various embodiments, the peripherals may be a PCMCIA card reader, a PC Card reader, a Compact Flash card reader, a barcode reader, a camera , and so forth. In various embodiments, the complementary electronics are packaged in an ASIC with output pins similar to that of a SIM chip, which may include a properly equipped protocol processor for de-packaging and packaging data being inputted/outputted in accordance with selected protocols. In one embodiment, the cover is U-shaped. In a wireless mobile phone embodiment, the cover is attached to a rotabable sub-section of a pivotable section.

### RELATED APPLICATION

This application is a continuation-in-part application, claiming priority to U.S. patent application Ser. No. 10/301,432, filed Nov. 20, 2002, entitled “ADDING PERIPHERALS TO MOBILE DEVICE VIA SMART INTERCHANGEABLE COVER”, which itself is a continuation-in-part application and claims priority to:

(a) U.S. patent application Ser. No. 10/087,098, filed Mar. 1, 2002, entitled “PERSONALIZING ELECTRONIC DEVICES AND SMART COVERING”, which itself claims priority to its provisional filing No. 60/306,326, on Jul. 17, 2001;

(b) U.S. patent application Ser. No. 09/932,154, filed Aug. 17, 2001, entitled “MOBILE ELECTRONIC DEVICE AND COVERING FOR SIMILAR DEVICES WITH ORNAMENT ATTACHMENT MECHANISM”, which itself claims priority to its provisional filing No. 60/292,123, on May 17, 2001; and

(c) U.S. Provisional Application No. 60/419,001, filed Oct. 15, 2002, entitled “Adding Peripherals to Mobile Devices via Smart Interchangeable Covers”.

### FIELD OF THE INVENTION

The present invention relates to the field of mobile devices. More specifically, the present invention is related to adding peripherals to mobile devices, such as wireless mobile phones, personal digital assistants (PDA) and so forth, via smart interchangeable covers.

### BACKGROUND OF THE INVENTION

Advances in microprocessor and telecommunication technology have led to wide spread deployment and adoption of mobile devices, such as wireless mobile phones and PDA. For wireless mobile phones, in addition to wireless telephony, the late models are often equipped with advanced capabilities, such as calendar, address book, games, access to the World Wide Web (WWW), emails, instant messaging, and so forth. Similarly, for PDA, in addition to calendar and address book functions, the late models are often equipped with advanced capabilities, such as wireless telephony, word processing, spreadsheets, and so forth. In other words, for advanced models, there are increasing cross over or convergent of the functionalities.

However, because of the compactness of the mobile device, typically only limited number of auxiliary and/or I/O peripherals (hereinafter, simply peripherals) are provided. For example, in the case of wireless mobile phones, typically only a 12-key keypad, a handful of control buttons, and limited amount of non-volatile storage are available, and in the case of PDA, only a handful of control buttons and limited amount of non-volatile storage are available. As a result, usability and in turn the user experience of these advanced functions are poor, which in turn leads to the reduced acceptance of the advanced functions, removal of economic incentives for further development and introduction of the advanced functions.

Some prior art mobile devices support the provision of addition peripherals, such as a keyboard, through attachment to an I/O port of the mobile device. However, as described earlier, because of the inherit compactness of mobile devices, only limited number of I/O ports, typically one, is available for attachment of external peripherals.

Thus, a need exists to provide additional peripherals to a mobile device in a more efficient manner.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of an interchangeable cover incorporated with the teachings of the present invention, in accordance with one embodiment;

FIG. 2 illustrates a back view of an interchangeable cover incorporated with the teachings of the present invention, in accordance with one embodiment;

FIGS. 3a-3b illustrate another perspective view of the interchangeable cover, in accordance with two embodiments;

FIG. 4 illustrates a perspective view of the interchangeable cover having been removably mated with a core unit of a mobile device, in accordance with one embodiment;

FIG. 5 illustrates an architectural view of the relevant electronic elements of the interchangeable cover of FIG. 1, in accordance with one embodiment;

FIG. 6 illustrates an architectural view of the mobile device of FIG. 3, in accordance with one embodiment;

FIGS. 7a-7b illustrate the operational flow of the relevant aspects of the device driver of FIG. 6, in accordance with one embodiment;

FIG. 8 illustrates an interchangeable cover incorporated with the teachings of the present invention, in accordance with an alternate embodiment; and

FIGS. 9a-9c illustrate an interchangeable over incorporated with the teachings of the present invention, in accordance with yet another embodiment.

### DETAILED DESCRIPTION OF EMBODIMENTS OF THE INVENTION

The present invention includes an interchangeable cover equipped to add peripherals to a mobile device.

Parts of the description will be presented in terms, such as mobile devices, cover, peripherals, interface and so forth, consistent with the manner commonly employed by those skilled in the art to convey the substance of their work to others skilled in the art. As well understood by those skilled in the art, the terms “mobile devices” as used herein, including in the claims, comprise wireless mobile phones, PDA, and other devices of the like.

The term “cover” as used herein refers to a part that inherently includes multiple surfaces that cover at least multiple ones of the exterior surfaces of the body or core unit of a mobile device, where the exterior surfaces are inherently disposed in different geometric planes. Accordingly, while a “cover” may come in many variants, as illustrated by the description to follow, a “card” like part, i.e. a part having the form factor of a “credit card”, a PCMCIA card, a PC card, a Compact Flash card and so forth, is not a “cover”, for the purpose of the present application. A “card” like part, for the purpose of the present application, by definition, is considered to occupy only one geometric plane. [PCMCIA=Personal Computer Memory Card International Association]

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. The phrase “in one embodiment” is used repeatedly. The phrase generally does not refer to the same embodiment, however, it may. The terms “comprising”, “having” and “including” are synonymous, unless the context dictates otherwise.

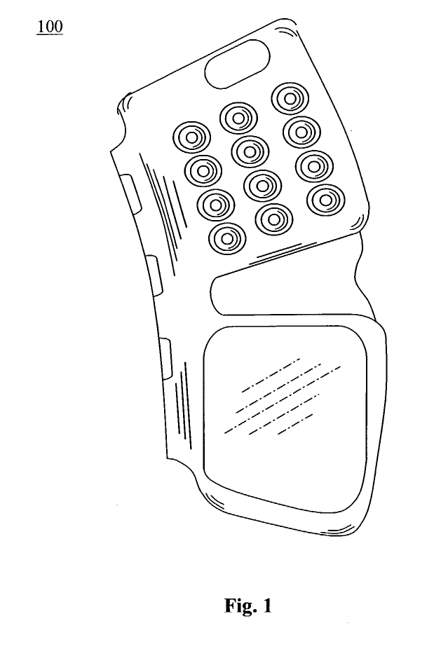

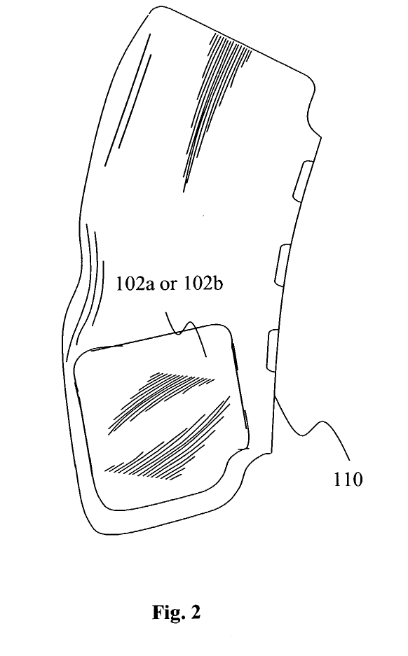

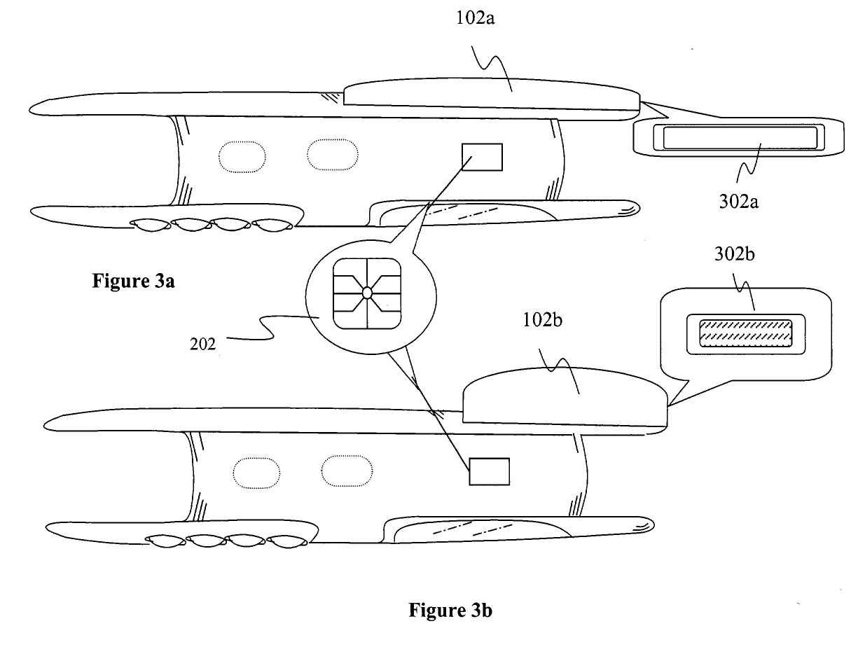

FIGS. 1-2 and 3a-3b illustrate an overview of the interchangeable cover of the present invention, in accordance with two embodiments. FIGS. 1-2 illustrate a front view and a back view of the cover of both embodiments respectively, which are substantially identical for these two embodiments, whereas FIG. 3a and 3b illustrate another perspective view of the cover of the two embodiments, which are different for these embodiments.

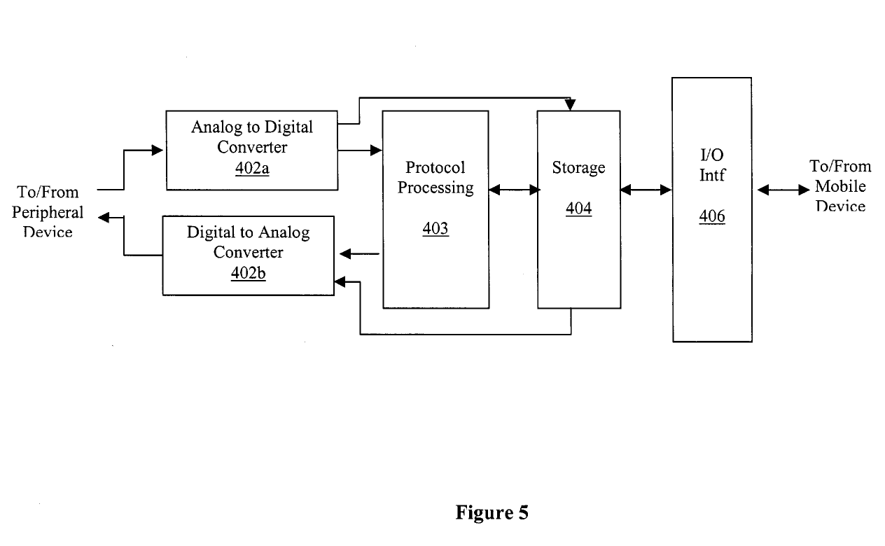

As illustrated, interchangeable cover 100 of the present invention is advantageously endowed with at least one peripheral 102a or 102b and complementary electronics (see FIGS. 3 and 5) to facilitate addition of peripherals 102a or -102b to a complementarily equipped mobile device, to which interchangeable cover 100 is attached.

For the illustrated embodiments, peripheral 102a represents a PCMCIA card reader, a PC Card reader, a Compact Flash card reader or other “receiving” readers of the like, with receiving opening 302a (FIG. 3), whereas peripheral 102b represents a barcode reader, a digital camera and other “lensed” devices of the like, with “lensed” end 302b (FIG. 3).

The only substantive difference between the two embodiments is the physical dimension of the integrated add-on peripheral. For the exemplary embodiments of FIG. 3a-3b, add-on peripheral 102a is relatively longer (in terms of its “run” along the surface of the cover) than add-on peripheral 102b, however add-on peripheral 102b is taller (in terms of its “rise” off the surface of the cover) than add-on peripheral 102a. Accordingly, integration of add-on peripheral 102a results in a longer but thinner “hump” at the back of cover 110, whereas integration of add-on peripheral 102b results in a shorter but thicker “hump” at the back of cover 110. In other words, the add-on peripheral may be any one of a number of complementarily dimensioned peripheral, suitable for integrating with cover 110, so long the resulting “hump” is not excessive to a point that would be so inconvenient or unacceptable to a user, to exchange for the added functionality.

Each of PCMCIA card reader, PC Card reader, Compact Flash card reader, barcode reader, and camera may be any one of a number of these devices with a compact form factor available from a number of respective manufacturers known in the industry. In particular, the barcode reader may support any one of a number of the barcode languages known in the art or to be developed. For examples, the barcode language may be, but not necessarily,

UPC-A or UPC-E

EAN

Code 3 of 9

Interleaved 2 of 5

Code 128

UCC/EAN -128

Codabar

PostNet

Pharmacode

PDF -417

The UPC-A bar code language is designed to encode numbers with a fixed length of 12 digits. The twelfth digit is a calculated check digit computed from the eleven prior digits. It is widely used for product identification in the retail industry in U.S.

UPC-E is similar to UPC-A, except it is designed to encode numbers with a fixed length of 8 digits only.

EAN is also similar to UPC-A, except it is designed to encode numbers with a fixed length of 13 digits. It is widely used for product identification in the retail industry outside U.S.

Code 3 of 9 (also referred to as Code 39) is designed to represent alphanumeric characters of varying length. The asterisk (*) character is used as the character sequence start/stop character.

Interleaved 2/5 is a high density encoding scheme, also designed to encode alphanumeric characters of variable length. However, only an even number of numeric data can be encoded within this symbol. The “double density” symbol encodes odd positioned data in the bars, and even positioned data in the spaces.

Code 128 is a very compact and versatile language designed to encode the entire 128 ASCII character set. The language is designed to be self-checking, and includes geometric features to improve scanner performance.

UCC/EAN-128 is an extension of Code 128, further including a special character (function 1) as part of the start code. In addition, UCC/EAN-128 utilizes standardized application identifiers. Codabar is designed to encode 16 alphanumeric characters,: 0-9 and 6 special characters (−$:/.+). The language also includes self-checking features.

Postnet is designed by the US Postal Service to encode ZIP code information on letter mail. The language differs from most other languages in that the individual bar code height alternates, rather than the bar width.

Pharmacode is designed to encode numeric data with values ranging from 1-8190. It is primarily used in packing control systems.

The PDF-417 is a high density encoding scheme, employing two dimensional bar codes consisting essentially of stacked lower bar code sets. PDF-417 is capable of encoding all 255 ASCII characters.

In alternate embodiments, peripherals 102a-102b may be peripherals of other types. Further, peripherals 102a-102b may be disposed in other locations of cover body 110 of cover 100.

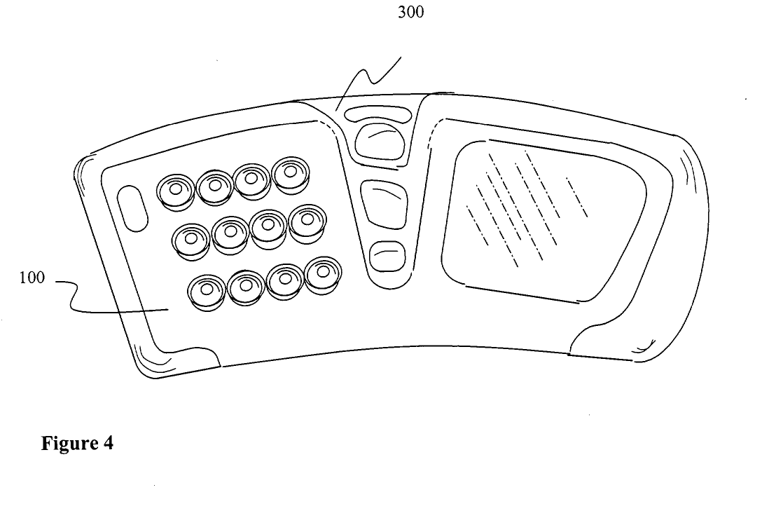

Still referring to FIG. 1, for the illustrated embodiment, cover body 110 of cover 100 has a substantially “rotated” U-shape or “taco shell” shape. Cover 100 is designed to attach to a core unit of a mobile device (such as the core unit of wireless mobile phone 300 of FIG. 4), in a side way manner (as denoted by arrow 310 of FIG. 4). For the embodiment, cover body 110 has multiple surfaces occupying different geometric planes, and covers at least partially each of a front, a side and a back exterior surface of the core unit of phone 300. For the embodiment, cover body 110 is designed to be snapped on to the core unit of a mobile device.

In alternate embodiments, cover body 110 may assume a body shape other than the illustrated “rotated” U-shape. Cover body 110 may also be designed to attach to a core unit of a mobile device in manner that is other than a side way manner. Similarly, cover body 110 may also be designed to attach to a core unit of a mobile device in a non-snapped on manner, even employing one or more fasteners. A number of these alternate embodiments are further described later.

As illustrated in FIGS. 3a-3b, the complementary electronics of cover 100 are packaged as an application specific integrated circuit (ASIC) 202. For the illustrated embodiment, ASIC 202 has output “pins” that are similar to the output pins of embedded ASIC found in what's commonly referred to as “SIM chips”. Further, ASIC 202 is disposed on the inside “side” surface of “rotated” U-shape body 110.

Peripherals 102a-102b are coupled to ASIC 202 by way of traces disposed on the inside surfaces of “rotated” U-shape body 110. In various embodiments, a protective interior layer may be included with cover body 110 to protect the traces. The protective interior layer may be made of any one of a number of known suitable materials, such as plastics.

In alternate embodiments, ASIC 202 may employ output “pins” of other types. ASIC 202 may be disposed in other location or locations of cover body 110. Further, the complementary electronics may be “packaged” in other manners.

FIG. 4 illustrates a perspective view of cover 100 of the present invention, attached to a core unit of a mobile device. For the illustrated embodiment, mobile device 300 is a wireless mobile phone. In particular, mobile device 300 includes an expansion I/O interface disposed at a “side” surface (covered by cover 100).

The expansion I/O interface comprises contacts that are complementary to the output “pins” of ASIC 202. Further, the expansion I/O interface is disposed at a location on an outer surface of the core unit of mobile device 300 corresponding to the disposition location of ASIC 202 on cover body 110.

From the descriptions to follow, it shall be readily apparent to one skilled in the art that the present invention may also be practiced with other types of interfaces, as well as with other mobile devices, in particular, personal digital assistants.

FIG. 5 illustrates an architectural view of the relevant complementary electronics, in accordance with one embodiment. For the embodiment, the relevant complementary electronics 400 includes an analog-to-digital converter 402a, a digital-to-analog converter 402b, protocol processor 403, storage unit 404, and input/output (I/O) interface 406, coupled to each other as shown.

Analog-to-digital converter 402a is employed to digitize the analog signals received from peripherals 102a-102b. Similarly, digital-to-analog converter 402b is employed to convert digital signals into analog signals for output to peripherals 102a-102b if necessary.

While the present invention is being described with add on peripherals that require A/D and D/A signal conversion, the present invention contemplates and includes the addition of peripherals that do not require such signal conversion. Modification of the described embodiments to arrive at such embodiments are well within the ability of those skilled in the art, accordingly will not be separately described.

Where applicable, protocol processor 403 is employed to recover the input data, and to package the output data for output in cases where data are inputted and outputted in accordance with a pre-defined protocol, e.g. a protocol in conformance to a particular PCMCIA, PC or Compact Flash card reader, a protocol in conformance to a particularbarcode reader or camera. Where applicable, for input data, protocol processor 403 performs the appropriate acknowledgement, processing of the header packet, extraction of data from the data packets, and so forth. Similarly, where applicable, for output data, protocol processor 403 performs the appropriate formation of data packets, formation of header packets, request for the serial bus and so forth.

Storage unit 404 is employed to store the digitized input data received from peripherals 102a-102b, and to store the digital data to be outputted to peripherals 102a-102b.

In various embodiments, storage unit 404 may be any one of a number of non-volatile memory known in the art, including but not limited to EEPROM, and so forth. In various embodiments, the storage locations of storage-unit 404 may be memory mapped into the memory space of mobile device 300.

I/O interface 406 facilitates an application or a system service of mobile device 300 in reading the inputs provided by peripherals 102a-120b, and to writing the outputs to be outputted to peripherals 102a-120b. As described earlier, I/O interface 406 may be any one of a number of I/O interfaces known in the art.

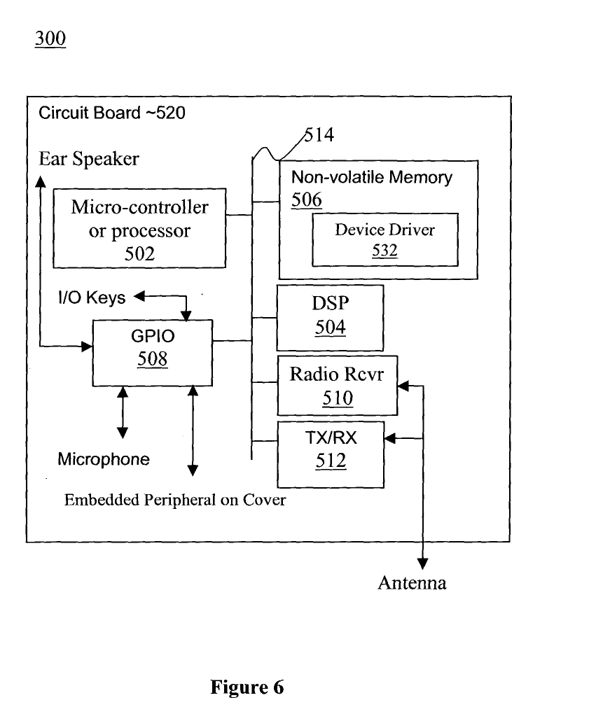

FIG. 6 illustrates mobile device 300 in further detail, in accordance with one embodiment. As alluded to earlier, for the illustrated embodiment, mobile device 300 is a wireless mobile phone; however, for other embodiments, mobile device 300 may be other mobile devices, including but are not limited to PDA.

As illustrated in FIG. 6, the core unit of wireless mobile phone 300 includes conventional elements, such as micro-controller/processor 502, digital signal processor (DSP) 504, non-volatile memory 506, general purpose input/output (GPIO) interface 508, radio receiver 510, and transmit/receive (TX/RX) 512 (also known as a transceiver), coupled to each other via bus 514, and disposed on a circuit board 520.

The core unit of wireless mobile phone 300 is endowed with a software implementation of a device driver 532 in support of the electronics packaged in ASIC 202.

Except for device driver 532 provided to mobile device 300, which relevant operating logic will be described more fully below, each of these elements 502-514 performs its conventional function known in the art, and is intended to represent a broad range of such element and its equivalents. In particular, GPIO 508 is configured to generate an interrupt notifying control processor 502 of data read from cover 100, which in turn directly or indirectly causes an application of mobile device 300 to be invoked and process the data read. Likewise, GPIO 508 is configured to write output data to be outputted to peripherals 102a/102b onto storage unit 404, on request of control processor 502.

Further, TX/RX 512 may be designed to support one or more of any of the known signaling protocols, including but are not limited to CDMA, TDMA, GSM, and so forth. Moreover TX/RX 512 may be implemented using separate transmitter and receiver.

Accordingly, elements 502-514 will not be further described.

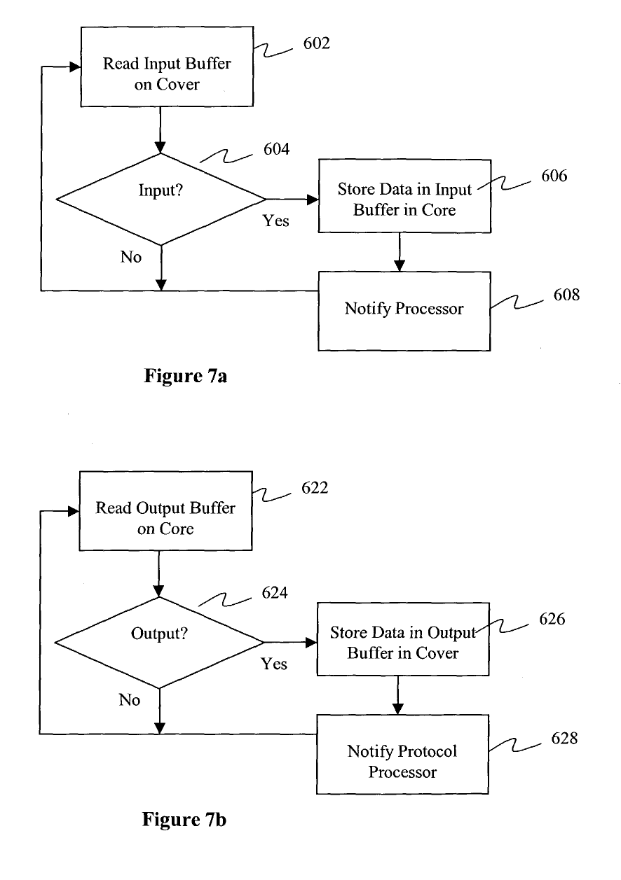

As illustrated in FIG. 7a, upon invocation, device driver 532 of mobile device 300 attempts to read the memory mapped storage locations of cover 100 (hereinafter, simply input buffer on cover 100), block 602. At block 604, device driver 532 determines if data were present and read. If no data were present and read, the process continues back at block 602.

However, if data were read, device driver 532 stores the data read in storage locations of memory 506 of mobile device 300 (hereinafter, simply, input buffer in mobile device 300), block 606. As alluded to earlier, device driver 532 further notifies processor 502, causing an application to process the data read, block 608. Thereafter, the process continues back at block 602 again.

Similarly, as illustrated in FIG. 7b, upon invocation, device driver 532 of mobile device 300 attempts to read the storage locations of cover 100 allocated for storing data to be outputted to peripherals 102a-102b (hereinafter, simply output buffer on mobile device 300), block 622. At block 624, device driver 532 determines if data were present and read. If no data were present and read, the process continues back at block 622.

However, if data were read, device driver 532 writes the data read out into storage locations of storage unit 404 of cover 100 (hereinafter, simply, output buffer of cover 100), block 626. If appropriate, device driver 532 further notifies protocol processor 403 to package the data for output to peripherals 102a-102b, block 628. Thereafter, the process continues back at block 622 again.

Accordingly, data may be advantageously inputted and/or outputted for mobile device 300 and peripherals 102a-120b.

### Alternate Embodiments

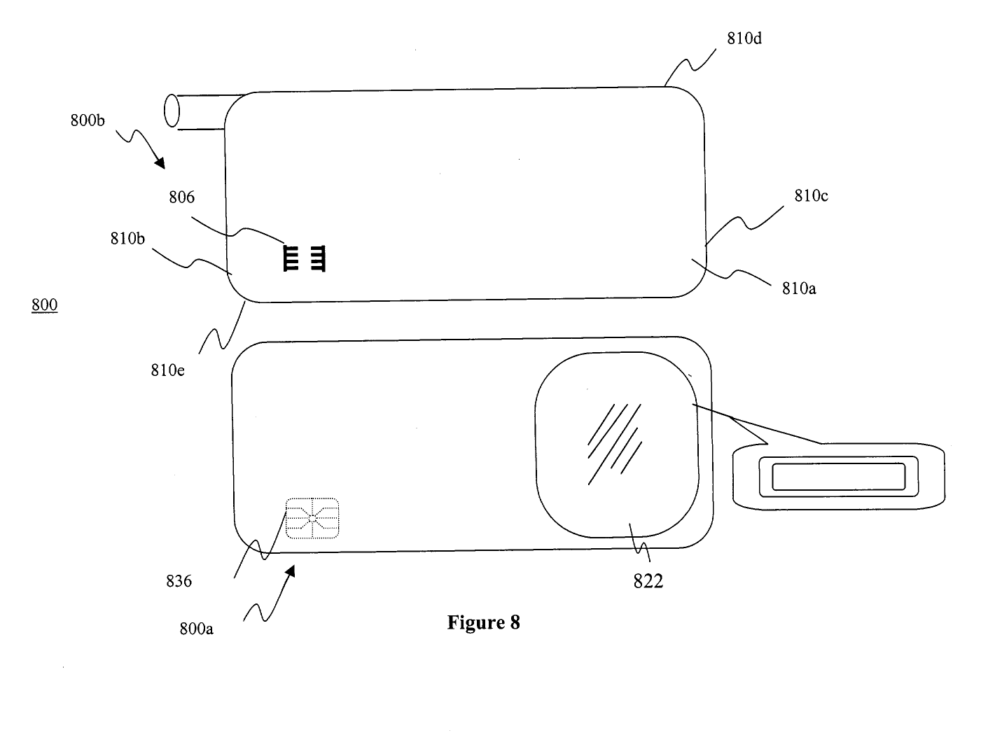

FIG. 8 illustrates an alternate embodiment of the present invention. More specifically, Fig, 8 illustrates an exploded view of a mobile phone 800 having core unit 800b and cover 800a, endowed with the teachings of the present invention. More specifically, the top part of FIG. 8 illustrates the back side of the exposed core unit 800b of mobile phone 800, and cover 800a is a removable back cover. Similar to mobile phone 300 of FIG. 4, core unit 800b of mobile phone 800 includes internal components similar to those of FIG. 6. As described earlier, the internal components are equipped with logic to enable additions of peripheral 822 to mobile phone 800, which may be peripherals analogous to peripherals 102a and 102b illustrated in FIG. 2 and 3a-3b. Further, core unit 800b includes a back and a number of side and end exteriors surfaces 810a-810e, disposed in different geometric planes.

When mated, cover 800a covers at least back surface 810a and one of the side and end surfaces 810b-810e of core unit 800b. As the embodiment of FIG. 1, cover 800a includes one or more peripherals 822, and electronic component 836 having earlier described complementary logic, to add one or more peripherals 822 to mobile device 800.

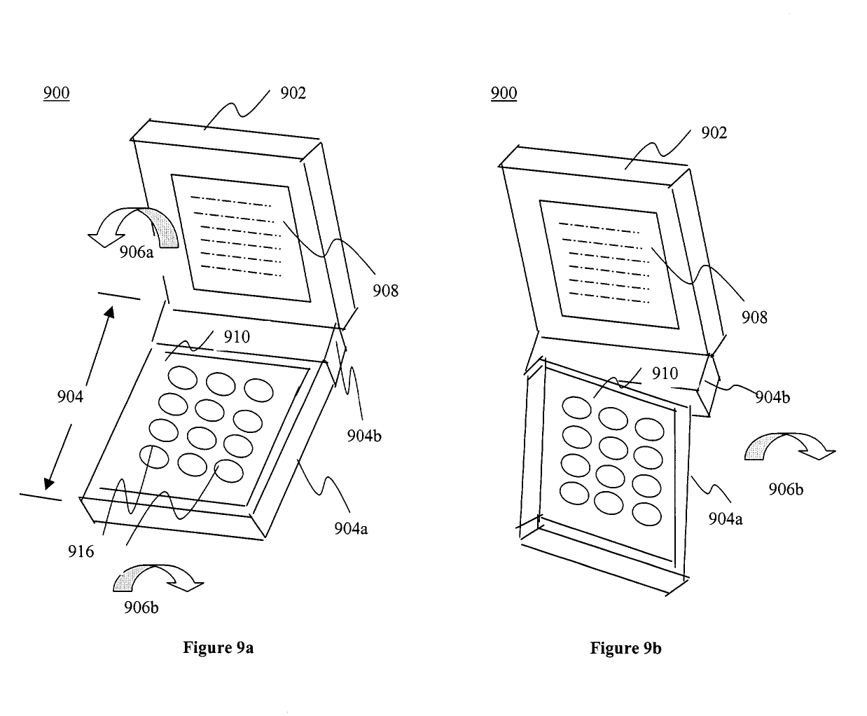

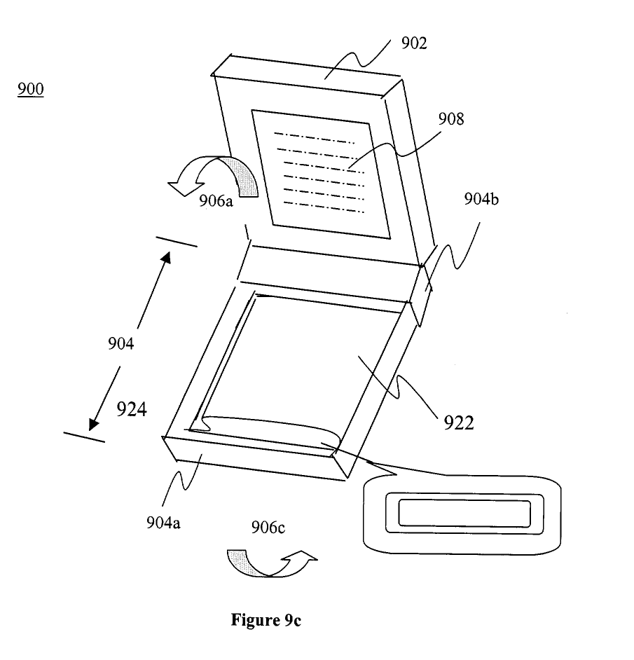

FIGS. 9a-9c illustrate yet another embodiment of the present invention. More specifically, FIGS. 9a-9c illustrate three mated views of a mobile phone 900 having a core unit and cover 910, endowed with the teachings of the present invention. Unlike the earlier described embodiments, the core unit of mobile phone 900 has a multi-section form factor comprising a first section 902 and a second section 904, and the second section 904 is further comprised of at least two sub-sections 904a-904b. The first and second sections 902-904 may pivot towards each other as denoted by direction arrow 906a or away from each other opposite to the direction denoted by arrow 906a. Sub-section 904a may rotate relative to sub-section 904b as denoted by the directions denoted by arrows 906b-906c. In other words, mobile phone 900 may be considered as an improved version of what is commonly referred to as “flip” phones.

Similar to mobile phones 300 and 800 of FIG. 4 and 8, the core unit of mobile phone 900 includes in particular, display 908, a number of input keys and expansion interface (covered by cover 910), and internal components similar to those of FIG. 6. As described earlier, the internal components are equipped with logic to enable additions of one or more peripherals 922 and/or 924 to mobile phone 900. Further, section 904 of mobile phone 900 with which cover 910 is to mate, includes a front and a number of side and end exteriors surfaces, disposed in different geometric planes.

Cover 910 is of a type similar to cover 100 of FIG. 1, i.e. U-shaped, except peripheral 922 to be added to mobile phone 900 and electronic component 926 are disposed on the inside and outside surfaces of the “back” surface respectively. Again, peripheral 922 may be a peripheral analogous to peripheral 102a or 102b illustrated in FIG. 3a-3b. As before, upon mating with section 904 of mobile phone 900, cover 910 covers at least partially a front surface and one of the side and end surfaces of section 904. For the embodiment, by rotating sub-section 904a relative to sub-section 904b of section 904, either input keys 916 or peripheral 922 may be made available for use in conjunction with display 908.

### Conclusion and Epilogue

Thus, it can be seen from the above descriptions, a novel method for adding peripherals to a mobile device, have been described.

While the present invention has been described in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An interchangeable cover comprising:
a cover body;
at least one peripheral disposed on the cover body;
traces coupled to the at least one peripheral; and
an electronic component coupled to the traces, and equipped to add the at least one peripheral to a mobile device to which the interchangeable cover is attached.

2. The cover of claim 1, wherein the cover body is U-shaped and designed to be attached to the mobile device from a side of the mobile device.

3. The cover of claim 1, wherein the cover is a back plate, with the cover body designed to be attached to the mobile device from a back of the mobile device.

4. The cover of claim 1, wherein the at least one peripheral comprises a selected one or a PCMCIA card reader and a PC Card reader.

5. The cover of claim 1, wherein the at least one peripheral comprises a Compact Flash card reader.

6. The cover of claim 1, wherein the at least one peripheral comprises a barcode reader.

7. The cover of claim 1, wherein the at least one peripheral comprises a digital camera.

8. The cover of claim 1, wherein at least one peripheral is disposed on a back surface of the cover body.

9. The cover of claim 1, wherein the electronic component comprises an analog-to-digital (A/D) converter and a digital-to-analog (D/A) converter coupled to the traces, a protocol processor coupled to the A/D and D/A converters, a storage unit coupled to the protocol processor and the converters, and an input/output (I/O) interface coupled to the storage unit.

10. The cover of claim 9, wherein the storage unit comprises EEPROM.

11. The cover of claims 1, wherein the mobile device comprises functionalities of at least a selected one of a wireless mobile phone and a personal digital assistant.

12. A mobile device comprising
a core unit including at least one extension interface; and
an interchangeable cover removably attached to the core unit, the interchangeable cover having at least one peripheral and electronics, coupled to each other, with at least one aspect of the electronics designed to mate with the at least one extension interface of the core unit to add the at least one peripheral to the core unit.

13. The mobile device of claim 12, wherein the interchangeable cover comprises a cover body that is U-shaped and designed to be attached to the mobile device from a side of the mobile device.

14. The mobile device of claim 12, wherein the interchangeable cover is a back plate designed to be attached to the mobile device from a front of the mobile device.

15. The mobile device of claim 12, wherein the at least one peripheral of the interchangeable cover comprises a selected one of a PCMCIA card reader and a PC card reader.

16. The mobile device of claim 12, wherein the at least one peripheral of the interchangeable cover comprises a barcode reader.

17. The mobile device of claim 12, wherein the at least one peripheral of the interchangeable cover comprises a digital camera.

18. The mobile device of claim 12, wherein the electronic components of the interchangeable cover comprise an analog-to-digital (A/D) converter and a digital-to-analog (D/A) converter, a protocol processor coupled to the A/D and D/A converters, a storage unit coupled to the protocol processor and the converters, and an input/output (I/O) interface coupled to the storage unit.

19. The mobile device of claim 18, wherein the storage unit comprises EEPROM.

20. The mobile device of claims 12, wherein the mobile device comprises functionalities of at least a selected one of a wireless mobile phone and a personal digital assistant.

21. The mobile device of claim 12, wherein the core unit comprises a first and a second section with the second section having a first and a second sub-section where the second-sub-section is rotatable relative to the first sub-section, and the cover removably attaches to the second sub-section of the second section.

22. A wireless mobile phone comprising:
a core wireless telephony unit including a first and a second section with the second section having a first and a second sub-section where the second sub-section is rotatable relative to the first sub-section; and
a cover including at least one peripheral, removably mated with the second sub-section,.

23. The wireless mobile phone of claim 22 wherein said at least one peripheral comprises a selected one of a PCMCIA card reader and a PC Card reader.

24. The wireless mobile phone of claim 22 wherein said at least one peripheral comprises a Compact Flash card reader.

25. The wireless mobile phone of claim 22 wherein said at least one peripheral comprises a barcode reader.

26. The wireless mobile phone of claim 22 wherein said at least one peripheral comprises a digital camera.

27. The wireless mobile phone of claim 22, wherein the first and the second sections are pivotally coupled to each other.
